(19) United States
(12) Patent Application Publication
(10) Pub. No.: US 2003/0110808 A1
(43) Pub. Date: Jun. 19, 2003

(54) Method of manufacturing an optical core

(75) Inventors: Hichem M'Saad, Santa Clara, CA (US); Anchuan Wang, Fremont, CA (US)

Correspondence Address: APPLIED MATERIALS, INC., 2881 SCOTT BLVD. M/S 2061, SANTA CLARA, CA, 95050, US

(73) Assignee: APPLIED MATERIALS INC., a Delaware corporation, Santa Clara, CA

(21) Appl. No.: 10/020,461

(22) Filed: Dec. 14, 2001

(51) Int. Cl. C03B 37/07

(52) U.S. Cl. 65/379; 65/386; 65/391; 65/397; 65/398

(57) ABSTRACT

Embodiments of the present invention provide a highly uniform low cost production worthy solution for manufacturing low propagation loss optical waveguides on a substrate. The method comprises depositing an optical core using a high-density plasma deposition process. The method is particularly advantageous in forming high contrast refractive index optical cores, such as SiOₓN_{y}, with drastically reduced propagation loss. In one embodiment the high-density plasma deposition process is an HDP-CVD process. In another embodiment the high-density plasma deposition process is an HDP-ECR process. In one embodiment, a method of forming an optical waveguide comprises forming at least one optical core on an undercladding layer of a substrate using a high-density plasma deposition process.

### CROSS REFERENCE TO RELATED APPLICATION

This application is related to commonly assigned and concurrently filed U.S. patent application Ser. No., __/___,___ (Unassigned), entitled “HDP-CVD FILM FOR UPPERCLADDING APPLICATION IN OPTICAL WAVEGUIDES,” by Hichem M'Saad (Attorney Docket Number A6139/T43800), the entire disclosure of which is hereby incorporated by reference for all purposes.

### BACKGROUND OF THE INVENTION

The present invention relates to the manufacture of integrated systems, and more particularly to a method for manufacturing optical cores with low loss. Optical cores manufactured according to the present invention are useful in a variety of applications, and are particularly useful in integrated optical systems that require low loss.

Optical systems are an emerging technology that offer solutions to many previously unsolvable technological problems. Thus, optical systems are now gaining an ever increasing importance in the technology world of today. Generally, optical systems utilize pulses of light rather than electric current to carry out such functions as data transmission, data routing, or other forms of data communication or data processing. One important structure commonly utilized in optical systems is an optical waveguide.

Optical waveguides are used to confine and direct light between the various components of an optical system. For example, optical waveguides may be used to carry Dense Wavelength Division Multiplexed (DWDM) light, which is used to increase the number of wavelengths in a single waveguide to achieve a higher aggregate bandwidth. FIG. 1 is a cross-sectional view of an optical fiber waveguide. The general structure of an optical waveguide 100 comprises two principal components: a core 103 and a cladding layer 102. The core 103 is the inner part of the fiber through which light is guided. It is surrounded completely by the cladding layer 102, which generally has a lower refractive index so that a light ray 105 in the core 103 that strikes the core/cladding boundary at a glancing angle is confined within the core 103 by total internal reflection. The confinement angle θ_{c} represents an upper limit for the angle at which the light ray 105 can strike the boundary and be confined within the core 103.

As more signals are incorporated into an optical waveguide channel, there is an increasing demand for components to route, switch, drop, and guide these light signals to their final destination. Many photonic components make this technology possible. These components include filters, modulators, amplifiers, couplers, multiplexers, optical cross-connects, Arrayed Waveguide Gratings (AWG), power splitters, and star couplers among others. However, as optical technology matures, it is desirable to monolithically integrate$various photonic components onto a single structure such as, for example, a silicon chip substrate or a glass substrate.

Attempts to integrate optical waveguides and photonic components onto a single chip have faced many challenges. For example, one optical waveguide core characteristic that is critical to the performance of an optical system is propagation loss, which is also referred to as attenuation. Attenuation refers to the loss of light energy as a pulse of light propagates down a waveguide channel. The two primary mechanisms of propagation loss are absorption and scattering. Absorption is caused by the interaction of the propagating light with impurities in the waveguide channel. For example, electrons in the impurities may absorb the light energy and undergo transitions. The electrons may then give up the absorbed energy by emitting light at other wavelengths or in the form of vibrational energy (i.e., heat or phonons). Thus, the manufacturing processes used for building the optical waveguide cores must minimize the introduction of impurities that lead to propagation loss from absorption.

The second primary mechanism, scattering, results from geometric imperfections in the fiber that cause light to be redirected out of the fiber, thus leading to an additional loss of light energy. Accordingly, optical waveguide core uniformity is of paramount importance. Therefore, for satisfactory optical waveguides, the manufacturing process has the additional critical requirement of providing integrated optical waveguide core structures that are highly uniform across the substrate structure upon which they are built. Furthermore, the manufacturing process must maintain such uniformity across multiple process runs.

At present, known integrated optical core manufacturing techniques have a variety of shortcomings. For instance, one prior art technique uses flame hydrolysis for depositing the optical core. However, flame hydrolysis processes are costly and lead to poor uniformity on large substrates. Another prior art technique uses a low pressure chemical vapor deposition process (“LPCVD”). However, known LPCVD techniques suffer from low deposition rates that result in increased production costs.

Yet another technique used to deposit optical cores is plasma-enhanced chemical vapor deposition processes (“PECVD”). However, currently available PECVD processes known to the inventor can lead to significant amounts of hydrogen in the optical core material, and thus result in integrated optical cores with propagation losses that are too high for many optical system requirements. In particular, known PECVD techniques are not generally suitable for manufacturing high contrast optical cores. High contrast optical cores (i.e., Δn>2%) typically include optical cores with high refractive indices (i.e., n>1.5). However, known PECVD techniques for forming optical cores with high refractive indices suffer from unsatisfactory propagation loss, or other detrimental limitations.

Thus, there is a need for an improved method of manufacturing an integrated optical core with high uniformity and minimal propagation loss to allow for the efficient integration of optical systems on a single structure in a low cost production environment.

### SUMMARY OF THE INVENTION

Embodiments of the present invention provide a highly uniform low cost production worthy solution for manufacturing low propagation loss optical waveguides on a substrate. The method comprises depositing an optical core using a high-density plasma deposition process. In one embodiment the high-density plasma deposition process is an HDP-CVD process. In another embodiment the high-density plasma deposition process is an HDP-ECR process. In one embodiment the method further comprises annealing the optical core after the high-density plasma deposition process.

In one embodiment, a method of forming an optical waveguide comprises depositing an undercladding layer over the substrate, and forming at least one optical core over the undercladding layer using a high-density plasma deposition process. The method may further comprise depositing an uppercladding layer over the at least one optical core.

In one embodiment the optical core is a silicon oxynitride (SiOₓN_{y}) core. In another embodiment the optical core is a doped silicate glass (e.g., phosphorus doped or germanium doped).

The methods of the present invention may be embodied in a computer-readable storage medium having a computer-readable program embodied therein for directing operation of a substrate processing system. Such a system may include a process chamber, a plasma generation system, a substrate holder, a gas delivery system, pressure controller, and a system controller. The computer-readable program includes instructions for operating the substrate processing system to form an optical waveguide on a substrate disposed in the processing chamber in accordance with the embodiments of the present invention.

A further understanding of the nature and advantages of the present invention may be realized by reference to the remaining portions of the specification and the drawings.

### BRIEF DESCRIPTION OF THE DRAWINGS

FIG. 1 is a cross-sectional view of an optical fiber waveguide;

FIG. 2 is a cross-sectional view of an optical waveguide according to one embodiment of the present invention;

FIG. 3 is a cross-sectional view of an optical waveguide having a core, an undercladding layer, and an uppercladding layer according to one embodiment of the present invention;

FIG. 4 shows a cross-section of a fiber and a graph illustrating the energy distribution of the light energy λ_{E} in the core;

FIG. 5 illustrates an optical waveguide structure according to one embodiment of the present invention;

FIG. 6 shows a graph of uniformity versus oxygen to silane ratio to illustrate improved uniformity according to one embodiment of the present invention;

FIGS. 7A-E illustrate a method of forming an optical waveguide core according to one embodiment of the present invention;

FIGS. 8A-E illustrate a method of forming an optical waveguide core according to another embodiment of the present invention;

FIG. 9 illustrates an optical waveguide structure according to another embodiment of the present invention;

FIG. 10A is a simplified diagram of one embodiment of a high-density plasma chemical vapor deposition system according to the present invention;

FIG. 10B is a simplified cross section of a gas ring that may be used in conjunction with the exemplary CVD processing chamber of FIG. 10A;

FIG. 10C is a simplified diagram of a monitor and light pen that may be used in conjunction with the exemplary CVD processing chamber of FIG. 10A;

FIG. 10D is a flow chart of an exemplary process control computer program product used to control the exemplary CVD processing chamber of FIG. 10A;

FIGS. 11A-J illustrate a comparison of a Fourier-transform infrared spectrum of an SiON core deposited using PECVD and HDP-CVD for refractive indices of 1.57-1.65; and

FIGS. 12A-J illustrate a comparison of a Fourier-transform infrared spectrum of an SiON core before and after annealing for refactive indices of 1.57-1.65.

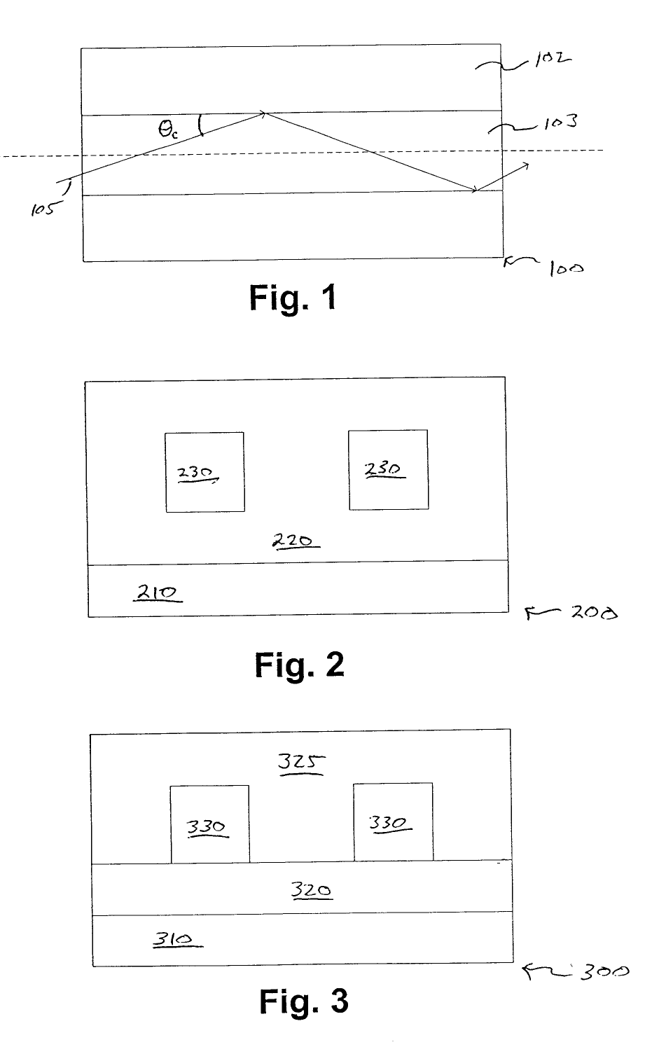

### DESCRIPTION OF THE SPECIFIC EMBODIMENTS

1. Formation of an Optical Waveguide

Embodiments of the present invention provide a highly uniform low cost production worthy solution for manufacturing low propagation loss optical waveguides on a substrate. The inventor has discovered that a high-density plasma process may be used to deposit optical cores to provide improved uniformity, propagation loss, and repeatability across manufacturing lots and systems over previous optical waveguide processing techniques. According to embodiments of the invention, a high-density-plasma (“HDP”) process is used for depositing an optical core on an optical waveguide structure. As used herein, a “high-density plasma” is understood to have an ion density that is equal to or exceeds 10¹¹ ions/cm³.

High-density plasma processes have previously been used primarily for processing electrical devices on a semiconductor substrate, where the principal concern is the electrical properties of materials, usually characterized by the dielectric constant and breakdown voltage. In contrast, the application of high-density plasma processes according to the present invention is concerned more with optical properties such as uniformity, and the desire to reduce propagation loss as much as possible.

Uniformity in optical waveguide applications requires an extremely tight film homogeneity across the substrate and between wafer to wafer. Refractive index tolerances can be constrained, for example, to within the range of ±0.0002, which is substantially more stringent than for semiconductor electronic fabrication processes. The inventor has discovered that uniformity at these tolerances may be achieved using a high-density plasma process, and it is believed that such uniformity results at least in part from a high dissociation efficiency of the utilized species in the processing chamber using a high-density plasma process.

In addition to providing improved uniformity, it was also discovered that a high-density plasma process may simultaneously result in reductions in the magnitude of propagation loss in the ultimate optical waveguide core. This result also stems at least in part from the dissociation of utilized species available in a high-density plasma process. For example, a high-density plasma process operates at a higher energy than either a PECVD or LPCVD process. Energy is generally a function of the pressure used in the processing chamber, and the power supplied to the processing chamber. Embodiments of the present invention form an optical core at a pressure of less than 100 millitorr, and using an RF power density of greater than 3 Watts/cm² (e.g., RF power>1000 Watts for a 200 mm wafer). In one embodiment, an optical core is formed at a pressure of approximately 10 millitorr, and using an RF power density of 10 Watts/cm² (i.e., RF power of approximately 3000 Watts for a 200 mm wafer).

Accordingly, a high-density plasma process can dissociate molecules with stronger bonds than can be dissociated with a PECVD or LPCVD process. Therefore, source gases that may have lower impurity containing elements, but higher bond energies, may be available for depositing the optical core in a high-density plasma process. However, such source gases may not be available for use in a PECVD or LPCVD process. Accordingly, with a wider selection of available source gases, a high-density plasma process can be tailored to reduce the impurities in the optical core that ultimately contribute to propagation loss.

FIG. 2 is a cross-sectional view of an optical waveguide 200 according to one embodiment of the present invention. The optical waveguide 200 may be manufactured on a substrate 210, which may be a silicon substrate, for example. However, it is to be understood that a variety of substrates could be used, such as a glass (i.e., silica) substrate, a lithium-niobate LiNbO₃ substrate, a silicon-germanium SiGe substrate, a III-V compound substrate (e.g., indium-phosphide InP or gallium-arsenide GaAs), or other suitable material. The optical waveguide 200 includes an optical waveguide core 230, which is completely surrounded by an optical cladding layer 220. The core 230 is the inner part of the fiber through which light is guided. The cladding layer 220 generally has a lower refractive index so that a light ray in the core that strikes the core/cladding boundary at a glancing angle is confined within the core by total internal reflection.

FIG. 3 is a cross-sectional view of an optical waveguide 300 having a core 330, an undercladding layer 320, and an uppercladding layer 325 according to one embodiment of the present invention. The optical waveguide 300 may be manufactured on a substrate 310, which may be a silicon substrate for example. The undercladding layer 320 is deposited over the substrate 310, and the optical core material 330 is deposited over undercladding layer 320. The optical core material 330 may then be patterned and etched. Uppercladding layer 325 may then be deposited over the optical core and undercladding layer. An exemplary technique for forming the undercladding layer 320 and uppercladding layer 325 employed by embodiments of the present invention are described in more detail in commonly owned, concurrently filed U.S. patent application Ser. No. __/___,___ (Unassigned), entitled “HDP-CVD FILM FOR UPPERCLADDING APPLICATION IN OPTICAL WAVEGUIDES,” by Hichem M'Saad (Attorney Docket Number A6139/T43800), the entire disclosure of which has been incorporated herein by reference in its entirety above.

Embodiments of the present invention include using a high-density plasma deposition process including a silicon source gas and an oxygen source gas to form a silicate glass optical core on a substrate. In one embodiment, the high-density plasma process is a chemical vapor deposition (“HDP-CVD”) process, while in another embodiment, the high-density plasma process is a electron cyclotron resonance (“HDP-ECR”) process. Exemplary silicon source gases may include SiₓH₂ₓ₊₂ (e.g., SiH₄, Si₂H₆, or Si₃H₈), SiₓH₂ₓ (e.g., Si₂H₄), SiH₂Cl₂, tetraethylorthosilicate (“TEOS”), methylsilane (i.e., (CH₃)SiH₃), dimethylsilane (i.e., (CH₃)₂SiH₂) or trimethylsilane (i.e., (CH₃)₃SiH). Additionally, exemplary oxygen source gases may include O₂, N₂O, CO₂, or CO.

In some embodiments, a dopant source gas may be provided during the high-density plasma deposition process to enhance the optical properties of the core. Dopant source gases may be used to increase the refractive index of the optical core. Undoped SiO₂ has a refractive index of approximately 1.46. However, the refractive index of an SiO₂ based core can be increased by doping the core with dopants that have greater resulting polarization than either oxygen or silicon. Embodiments of the present invention may utilize nitrogen, phosphorus, germanium, or other atoms that increase core polarization, as dopants for the optical core. For example, in one embodiment, a nitrogen containing gas may be used as a dopant source gas to form an SiOₓN_{y} optical waveguide core. The silicon-nitrogen bond has a greater polarization than a silicon-oxygen bond, and thus, the refractive index of the doped core is increased. Exemplary nitrogen containing source gases may include NH₃, N₂, and N₂O. Alternatively, a phosphorus containing gas may be used as a dopant source gas to increase the refractive index of the core because phosphorus results in a greater polarization than oxygen. An exemplary phosphorus containing source gas may include PH₃. Moreover, a germanium containing gas may be used as a dopant source gas to increase the refractive index of the core because germanium results in a greater polarization than silicon. Exemplary germanium containing source gases may include germane (GeH₄), digermane (Ge₂H₆), or trigermane (Ge₃H₈).

Embodiments of the present invention are particularly advantageous for forming high contrast optical cores. The contrast, Δn, of an optical core is given by the following equation:

$$Δ n = \frac{{n}_{core} - {n}_{cladding}}{{n}_{core}}$$

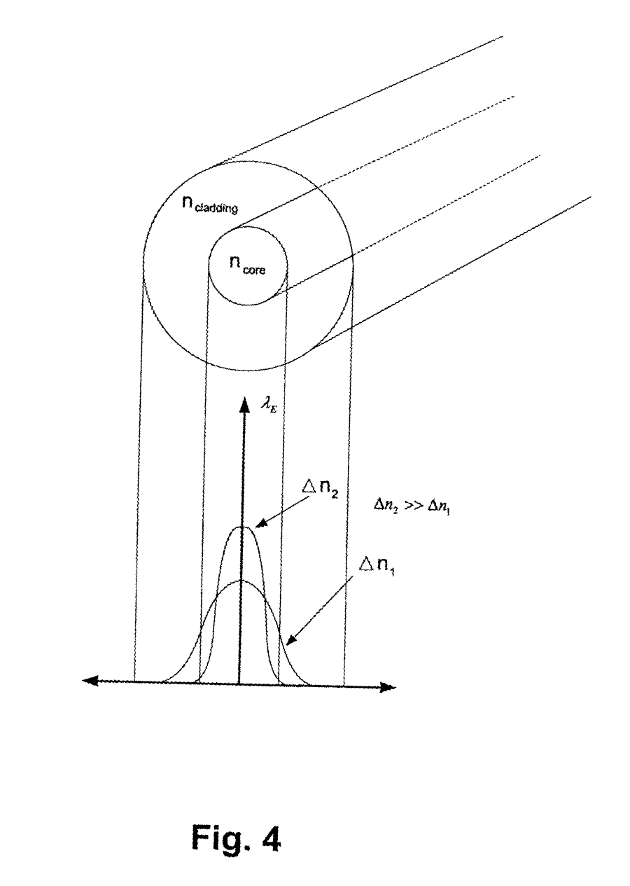

As mentioned above, high contrast optical cores typically have a Δn>2%, and typically include optical cores with higher refractive indices. High contrast cores are advantageous because as the contrast increases, the refractive index of the core is typically increased, and thus more of the light is optically confined in the core, thereby allowing for thinner optical cores. FIG. 4 illustrates this concept. FIG. 4 shows a cross-section of a fiber and a graph illustrating the energy distribution of the light energy λ_{E} in the core. As shown in FIG. 4, as the contrast Δn increases, more of the light energy is confined within the core, and less light energy is in the claddir.g layer. Therefore, thinner cores can be used to carry the optical signals.

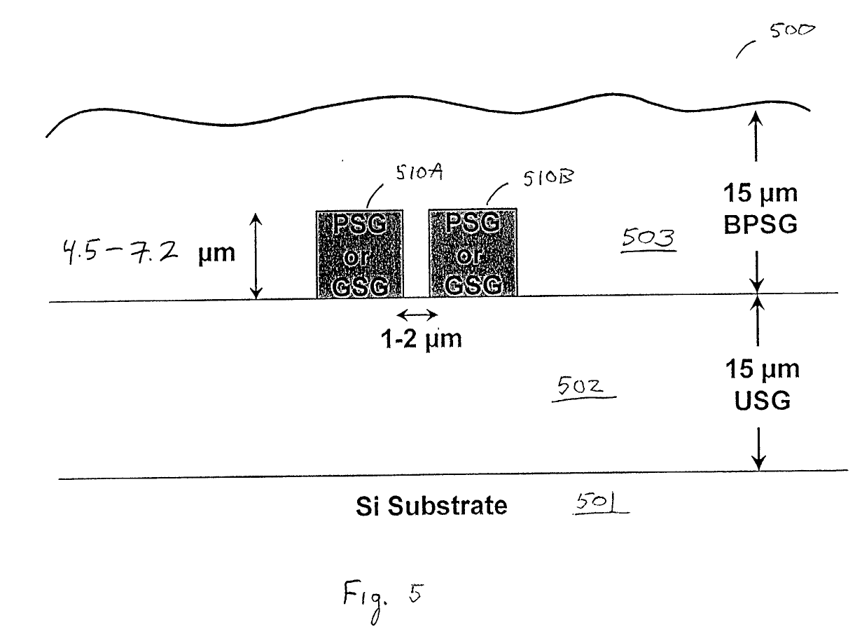

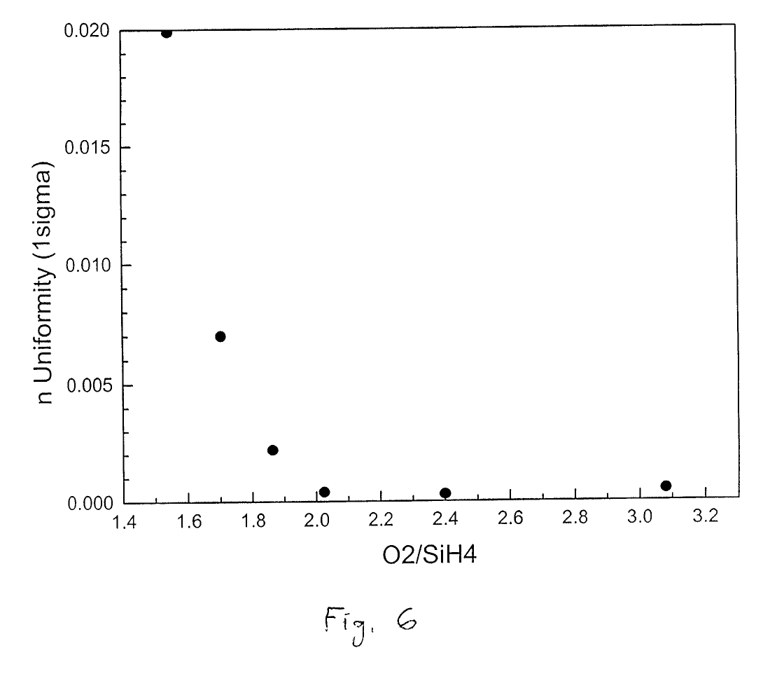

FIG. 5 illustrates an optical waveguide structure according to one embodiment of the present invention. The optical waveguide 500 may include phosphorous doped silicate glass (“PSG”) or germanium doped silicate glass (“GSG”) optical cores 510A and 510B deposited using a high-density plasma process. The optical waveguide 500 also includes a 15 μm USG layer 502 formed on a substrate 501. The USG layer 502 is the undercladding layer of the optical cores 510A and 510B. The uppercladding layer comprises a 15 μm BPSG layer 503. Typical PSG or GSG optical cores 510A and 510B may be 4.5-7.2 μm thick and separated by 1-2 μm for a refractive index of 1.467-1.480, for example. However, as stated above, for higher refractive indices, thinner cores may be used. For example, for a refractive index of approximately 1.6, a thickness of between 2-2.5 may be used.

In another embodiment of the present invention, a high-density plasma process including a silicon source gas, oxygen source gas, and nitrogen source gas is used to manufacture an SiOₓN_{y} optical waveguide core. As stated above, a variety of gases could be used as the silicon source, oxygen source, and nitrogen source. However, in one particularly advantageous embodiment, silane, SiH₄, is used as the silicon source gas, molecular oxygen, O₂, is used as the oxygen source, and molecular nitrogen, N₂, is used as the nitrogen source. Embodiments of the present invention typically utilize an oxygen source to silane source ratio of greater than 1.5. Additionally, the ratio of the nitrogen source to the silane source may be between 0.5-5.0. Furthermore, the ratio of the oxygen source to the nitrogen source may be between 0.6-6.0.

One advantage of the present invention is that a high-density plasma process allows for use of N₂ gas as a source for an SiOₓN_{y} core. If an SiOₓN_{y} core were deposited using PECVD or LPCVD, NH₃ would typically be used as the nitrogen source, rather than N₂, because neither PECVD nor LPCVD have sufficient energy to adequately break the strong nitrogen to nitrogen bond in N₂. However, according to one embodiment of the present invention a drastic improvement in propagation loss can be achieved by using N₂ as a source gas, rather than NH₃, in a high-density plasma process. This improvement is derived from the reduced formation of NH in the optical core that can be achieved by using N₂, rather than NH₃. Moreover, in one embodiment, optical properties may be further improved by using a high N₂ flow rate. An increased N₂ flow rate improves repeatability from wafer to wafer and system to system, and also improves the refractive index tuning capability. For example, one recipe may use an N₂ flow rate of between 300-500 sccm to achieve these additional advantages.

Features and advantages of the present invention further include the utilization of a high-density plasma process for depositing an optical core with improved uniformity. As previously mentioned, a particular concern with the fabrication of optical waveguides is that the processes utilized must result in highly uniform structures. The inventor has discovered that carrying out the high-density plasma deposition process in an oxygen rich environment results in optical cores with refractive index uniformity levels that are satisfactory for optical applications. More particularly, improvements in uniformity have been found where the ratio of molecular oxygen to the silicon atoms in the silicon source gas is greater than 1.5:1 (i.e., a 3:1 ratio of atomic oxygen to silicon). For example, in one embodiment of the present invention a ratio of O₂:SiH₄ that is greater than 1.5:1 is used. Alternatively, if other silicon source gases were used, the ratio may change according to silicon content. For example, if Si₂H₆ were used, then a ratio of O₂:Si₂H₆ that is greater than 3:1 may be used.

FIG. 6 shows a graph of uniformity versus oxygen-to-silane ratio to illustrate improved uniformity achieved from a high-density plasma process carried out in an oxygen rich environment. It should be noted that in the semiconductor field, typical high-density processes would use an O₂ flow rate of less than 100 sccm for gap filling. However, embodiments of the present invention utilize increased flow rates of O₂ (e.g., 200-600 sccm), increased oxygen-to-silane ratios, and increased flow rates of N₂ (e.g., 300-500 sccm) to achieve advantageous optical properties in the deposited film.

Further advantages may be achieved by carrying out the high-density plasma process with increased processing temperatures to further improve optical properties. For example, in one embodiment, processing temperatures greater than 600° C. can be used during the high-density plasma deposition of the optical core. Increased processing temperatures may be achieved by processing the wafer without a heat sink. For example, increased temperatures may be achieved by not chucking the wafer. Additionally, increased temperatures may be achieved by using argon rather than helium. Increased processing temperatures during the optical core deposition step are advantageous because high temperatures lead to a higher desorption and thus further reduce hydrogen content.

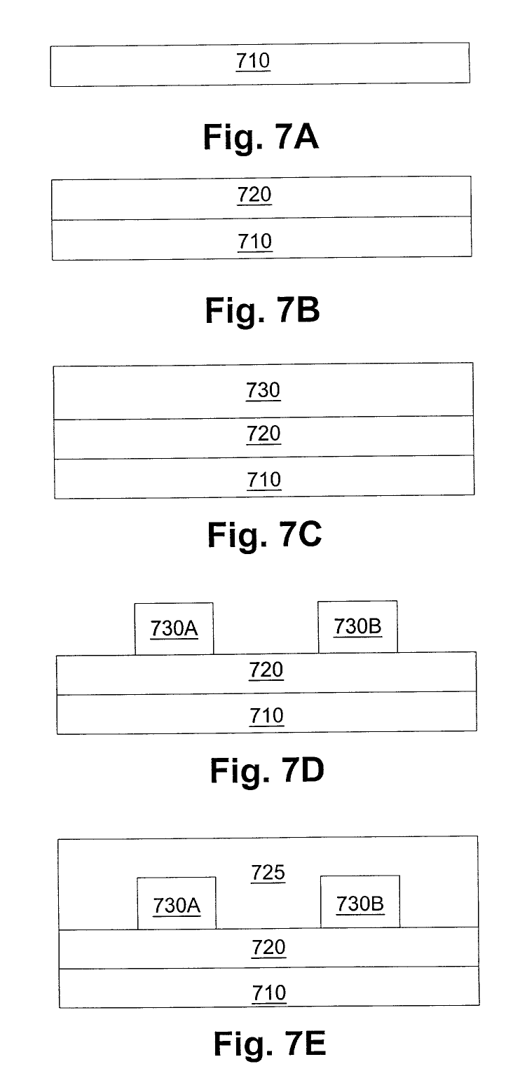

FIGS. 7A-7E illustrate a first method of forming an optical waveguide core according to one embodiment of the present invention. The technique used in FIGS. 7A-7E includes forming a continuous core layer across the entire substrate, then defining the optical cores by patterning, and then etching away unwanted portions of the core layer. This approach is sometimes referred to as a blanket-etch approach. As shown in FIG. 7A, a silica substrate 710 may be used as the base for the optical waveguide. An undercladding layer 720 is then formed over substrate 710 (FIG. 7B). In one particular embodiment, undercladding layer 720 is formed of undoped SiO₂ (“USG”), but more generally, the undercladding layer 720 may be formed from any material having a lower refractive index than the core material. The undercladding layer 720 is typically a thermal oxide or a high-pressure oxide.

Next, a continuous optical core layer 730 is formed over undercladding layer 720 (FIG. 7C). Optical core layer 730 is formed using a high-density plasma process such as an HDP-CVD process or an HDP-ECR process. In the embodiment shown in FIGS. 7A-7E, a continuous optical core layer 730 is formed across the entire wafer surface. Because the deposition surface is substantially flat and includes no trenches, no gap filling is required. Accordingly, the high-density plamsa process may be used with no RF bias. This has the effect of further reducing the hydrogen content in the optical core layer 730 because RF bias has been found to cause increases in hydrogen content in the deposited core.

After deposition of the continuous optical core layer 730, the layer is etched to form at least one optical core (FIG. 7D). Techniques for etching doped silicate glass layers, such as SiOₓN_{y} and others, are well-known to those skilled in the art and are not described here. Two optical cores 730A and 730B are illustrated in FIG. 7D. An anneal step may also be included before etch to further improve the propagation loss. An anneal step may utilize a temperature between 1000-1100° C. for between 2-4 hours. In one exemplary embodiment, a 10-20% reduction in NH content may be achieved by an anneal step carried out at 1000° C. for 2 hours.

An uppercladding layer 725 is then formed over the optical cores 730A and 730B (FIG. 7E). In some embodiments of the invention, uppercladding layer 725 is a fluorine-doped silicate glass film deposited using an HDP technique, which as mentioned above, is described in nore detail in commonly owned, concurrently filed U.S. patent application Ser. No. __/___,___ (Unassigned), entitled “HDP-CVD FILM FOR UPPERCLADDING APPLICATION IN OPTICAL WAVEGUIDES,” by Hichem M'Saad (Attorney Docket Number A6139/T43800), the entire disclosure of which has been incorporated by reference for all purposes above. It will be appreciated that if more than one optical core is formed, for example optical cores 730A and 730B , then gaps between the optical cores 730A and 730B are typically filled as fully as possible with appropriate gap filling techniques during the deposition of layer 725.

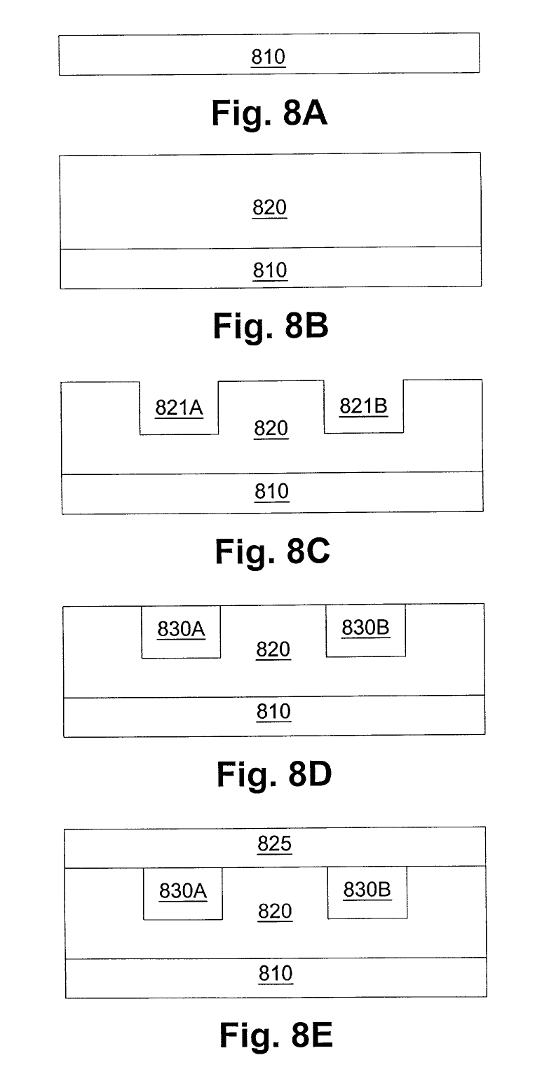

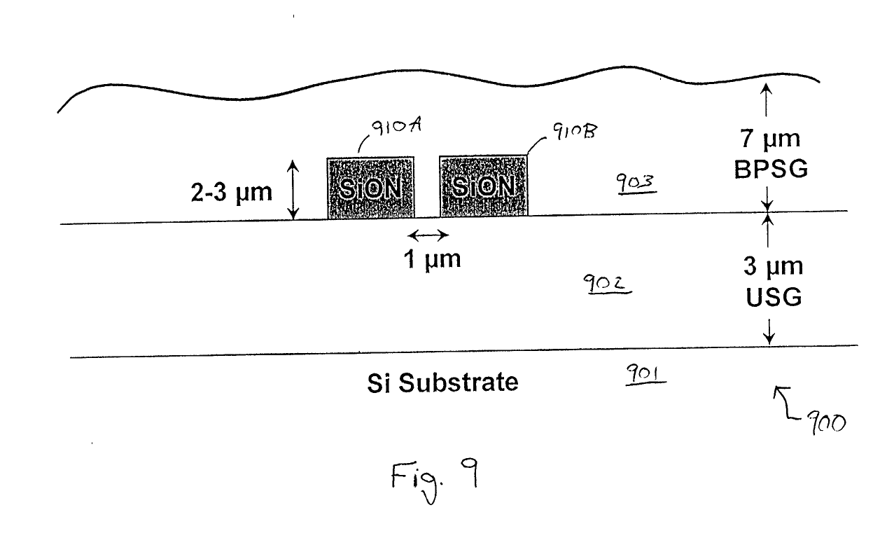

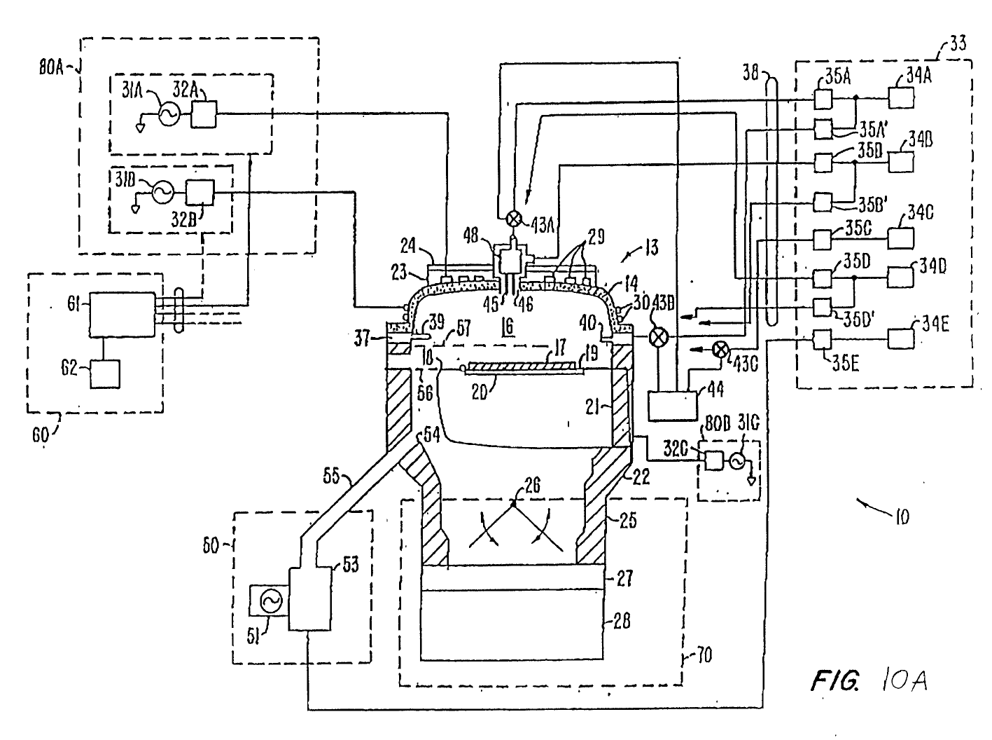

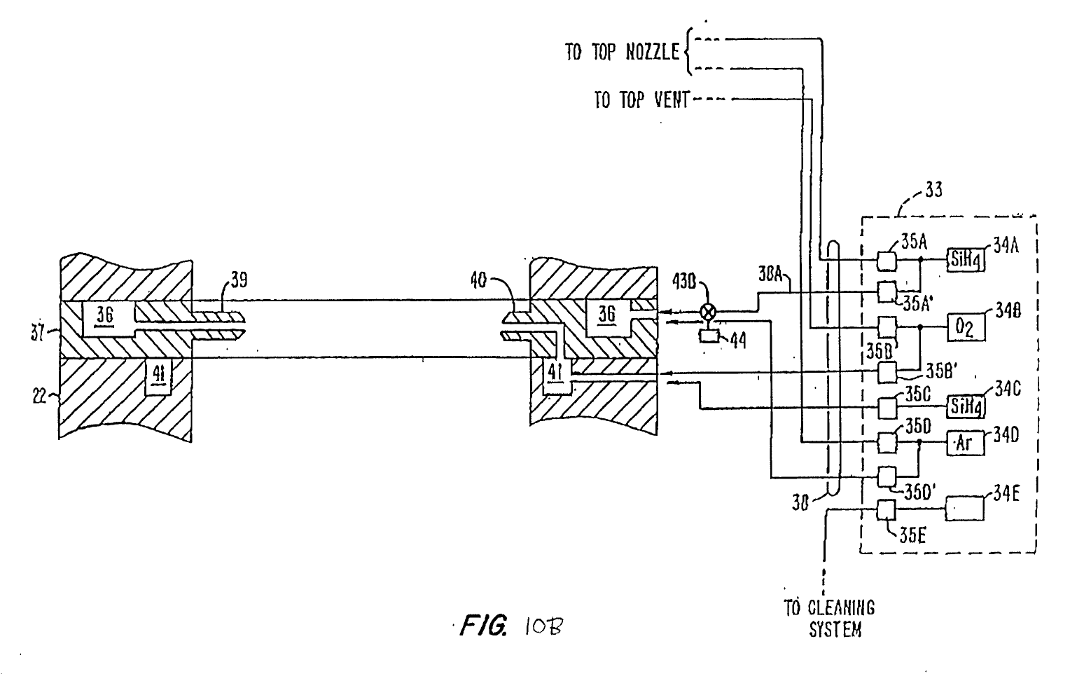

FIGS. 8A-E illustrate a second method of forming an optical waveguide core according to another embodiment of the present invention. The technique used in FIGS. 8A-8E includes laying down the undercladding layer across the entire substrate and then forming trenches in the undercladding layer for receiving and defining optical cores. This approach is sometimes referred to as a gap-fill or “Damascene” approach. As shown in FIG. 8A, a substrate 810 may be used as the base for the optical waveguide. An undercladding layer 820 is formed over substrate 810 (FIG. 8B). The undercladding layer 820 may typically be a thermal oxide or a high-pressure oxide. For the present embodiment, the undercladding layer 820 is deposited to a thickness sufficient to include the thickness of the optical core material. Next, the undercladding layer 820 is etched to form at least one trench 821 (FIG. 8C). Optical cores 830A and 830B are then deposited using a high-density plasma process in the trenches 821 in the undercladding layer 820 (FIG. 8D).

In the embodiment shown in FIGS. 8A-8E, the optical cores are deposited in trenches, and therefore, trench filling techniques are required. Accordingly, an RF bias may be used in this case with the high-density plasma process to improve trench filling during the optical core deposition. For example, in one embodiment, an RF bias power density of between 0 to 16 watts per square centimeter is used to improve trench filling of the deposition. Additionally, a chemical mechanical polish (“CMP”) or etch will typically be used to planarize the surface and expose optical cores 830A and 830B, and undercladding layer 820, before deposition of the uppercladding layer 825. After a CMP, uppercladding layer 825 may then be formed over the exposed optical cores 830A and 830B, and exposed undercladding layer 820 (FIG. 8E).

FIG. 9 illustrates an optical waveguide structure according to one embodiment of the present invention. The optical waveguide 900 includes SiON optical cores 910A and 910B deposited using a high-density plasma process. Optical waveguide 900 may also include a USG layer 902 formed on a substrate 901. A typical thickness for an exemplary USG layer 902 may be 3 μm, for example. The USG layer 902 is the undercladding layer of the optical cores 910A and 910B. Uppercladding layer 903 is also included, and may comprise a 7 μm thick layer of borophosphosilicate glass (“BPSG”). Typical SiON optical cores 910A and 910B may be 2-3 μm thick and may be separated by 1 μm, for example.

One suitable process recipe for depositing an SiON optical core having a refractive index of approximately 1.6 on a 200 mm substrate using an HDP-CVD process according to one embodiment of the present invention is summarized in Table 1 below:

TABLE 1

| Process Parameter | Range | Value |
|---|---|---|
| Φₜₒₚ(SiH₄) (sccm) | 3-12 | 5 |
| Φ_{side}(SiH₄) (sccm) | 40-80 | 58 |
| Φ(O₂) (sccm) | 60-250 | 88 |
| Φ(N₂) (sccm) | 30-300 | 200 |
| Φ(Ar) (sccm) | 50-300 | 100 |
| Source RF Density - Top (Watts/cm²) | 2.5-5.5 | 4 |
| Source RF Density - Side (Watts/cm²) | 7.5—12 | 10 |
| Bias RF Density (Watts/cm²) | 0 | 0 |
| Deposition Rate (Å/min) | 4000-4500 | 4200 |
| Pressure (millitorr) | <100 | 10 |
| Dome Temp | NA | 125 |
| Chuck | NA | OFF |

For the recipe shown in Table 1, argon is used as a carrier gas. As a noble gas, argon stabilizes the high-density plasma because noble gases ionize more easily, thereby helping the dissociation of other species in the plasma. It is to be understood, however, that other carrier gases such as helium, neon, xenon, or krypton could also be used.

A process recipe for depositing an SiON optical core having a refractive index of approximately 1.5 on a 200 mm substrate using a HDP-CVD process according to another embodiment of the present invention is summarized in Table 2 below:

TABLE 2

| Process Parameter | Range | Value |
|---|---|---|
| Φₜₒₚ(SiH₄) (sccm) | 3-12 | 7 |
| Φ_{side}(SiH₄) (sccm) | 40-80 | 50 |
| Φ(O₂) (sccm) | 60-250 | 235 |
| Φ(N₂) (sccm) | 30-300 | 80 |
| Φ(Ar) (sccm) | 50-300 | 100 |
| Source RF Density - Top (Watts/cm²) | 2.5-5.5 | 4 |
| Source RF Density - Side (Watts/cm²) | 7.5-12 | 10 |
| Bias RF Density (Watts/cm²) | 0 | 0 |
| Deposition Rate (Å/min) | 4000-4500 | 4000 |
| Pressure (millitorr) | <100 | 10 |
| Dome Temp | NA | 125 |
| Chuck | NA | OFF |

In some embodiments, larger substrates may be advantageous for integrating optical systems on a single substrate. Therefore, larger substrates such as 300 mm substrates, for example, may be utilized. The advantageous high level of uniformity achieved by the techniques of the present invention, as mentioned above, allows for accurate manufacturing of large substrates having a diameters of 200 mm to 300 mm or more. The recipes present in Tables 1 and 2 may be scaled to larger substrates by multiplying each parameter, except power density, by a scaling factor. For example, to scale from 200 mm to 300 mm, a scaling factor of approximately 2.25 may be used. Also, a person skilled in the art will recognize that these values are in part chamber specific. Gas flow rates, RF power levels, and other variables set forth herein have been determined for an ULTIMA™ system, manufactured by APPLIED MATERIALS, INC., of Santa Clara, Calif., and configured for 200 mm substrates. These values may differ for chambers of other design and/or volume.

2. Exemplary HDP-CVD Substrate Processing System

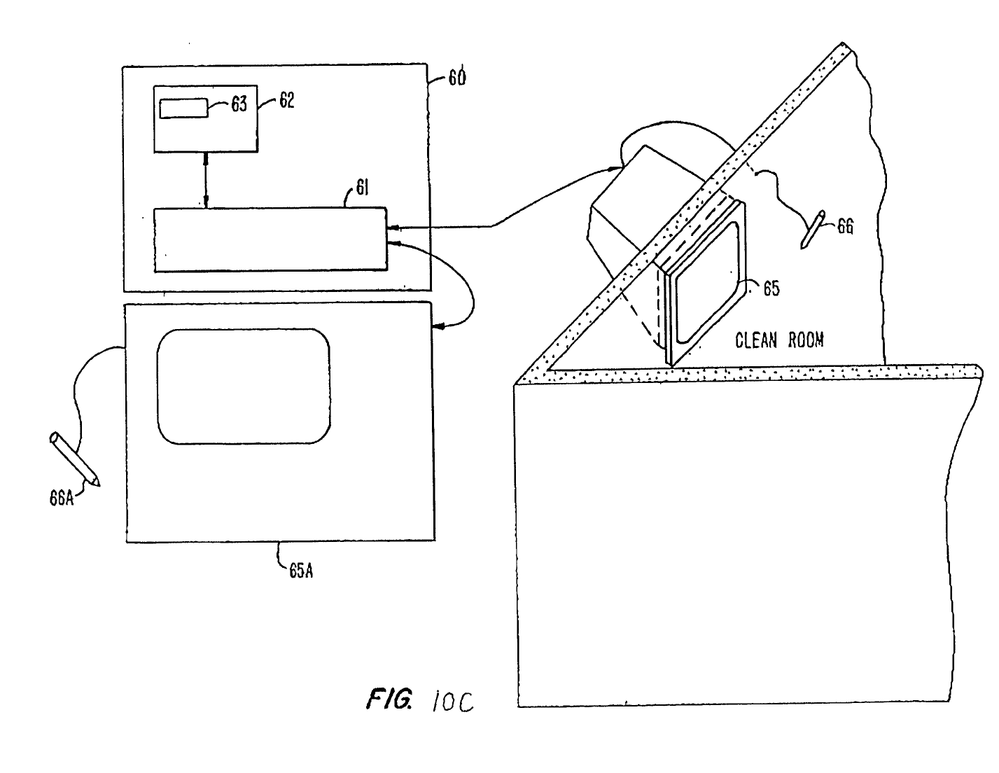

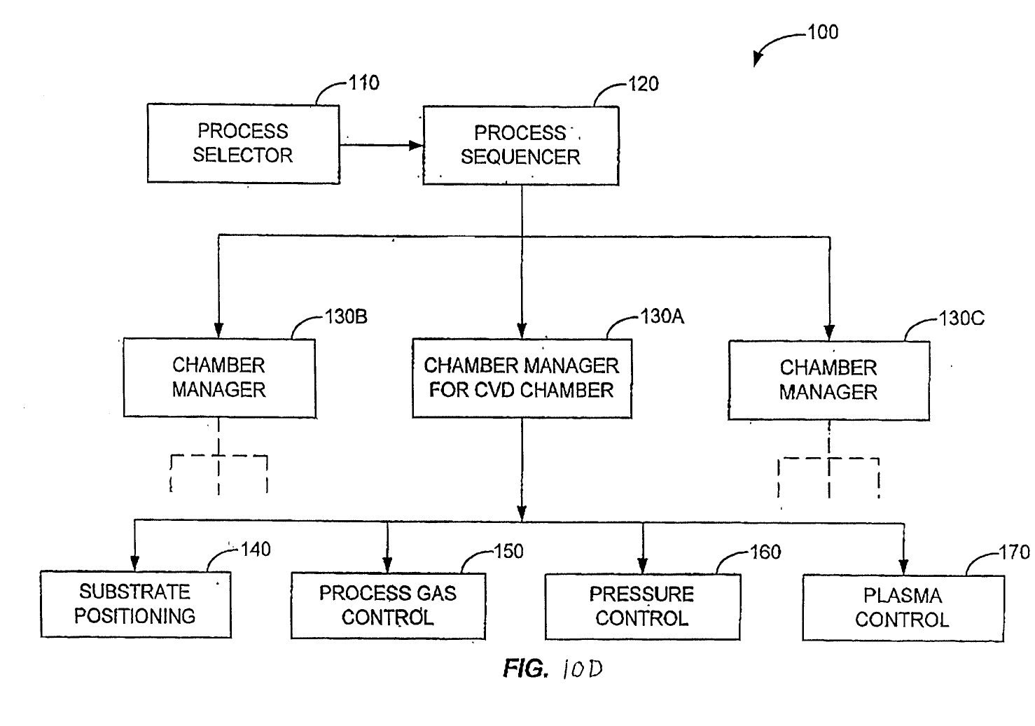

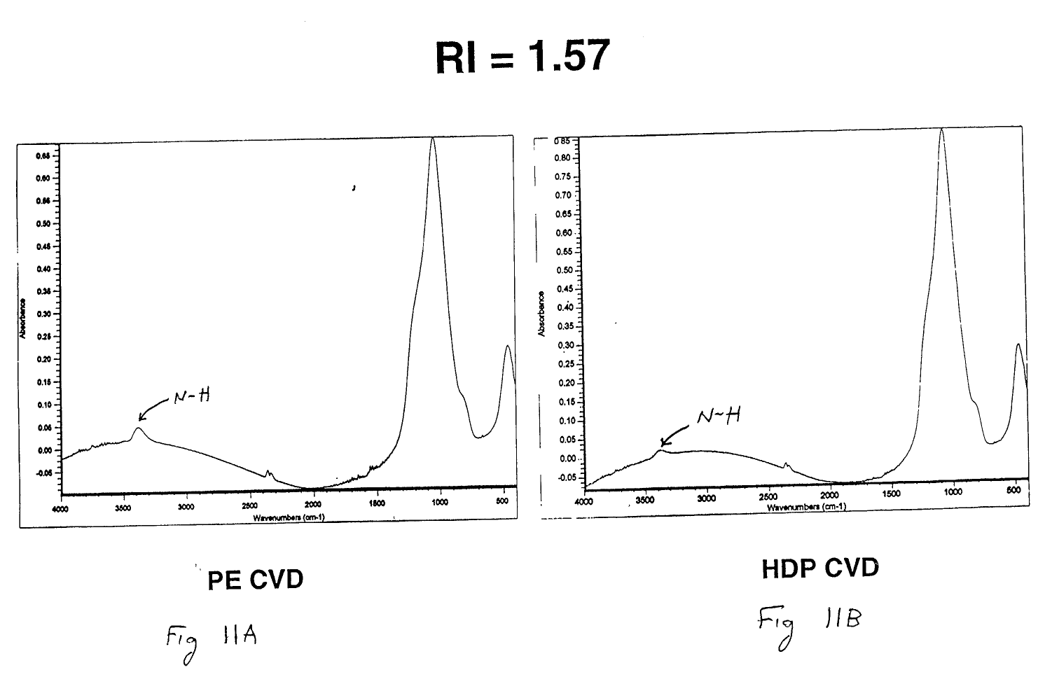

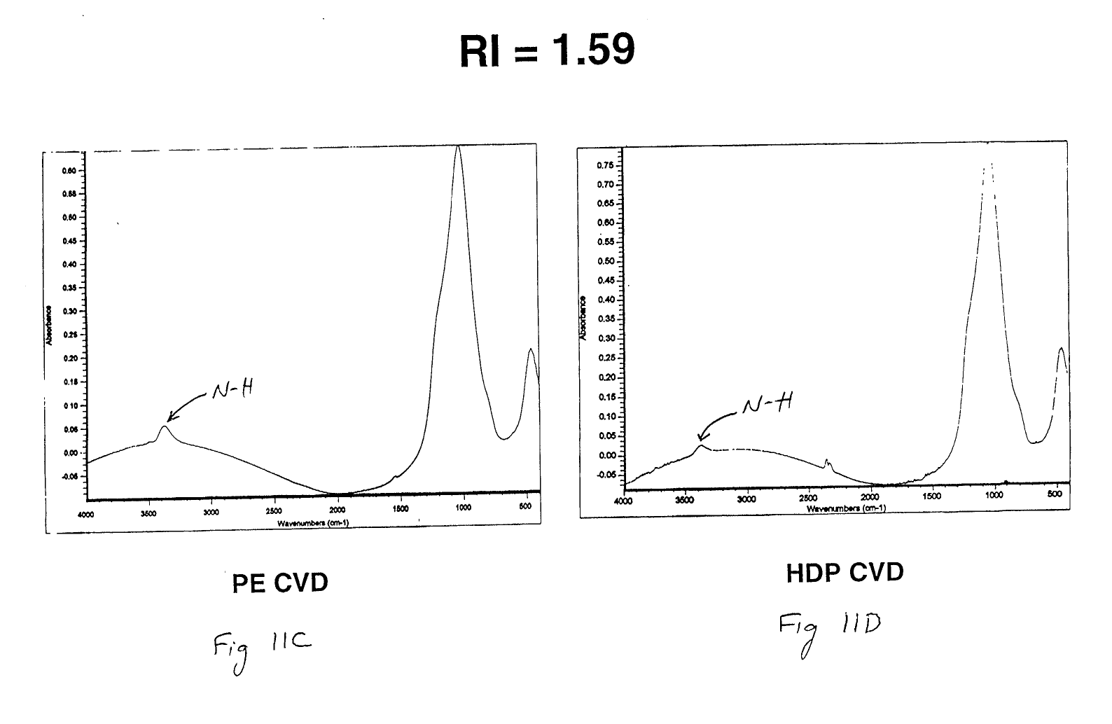

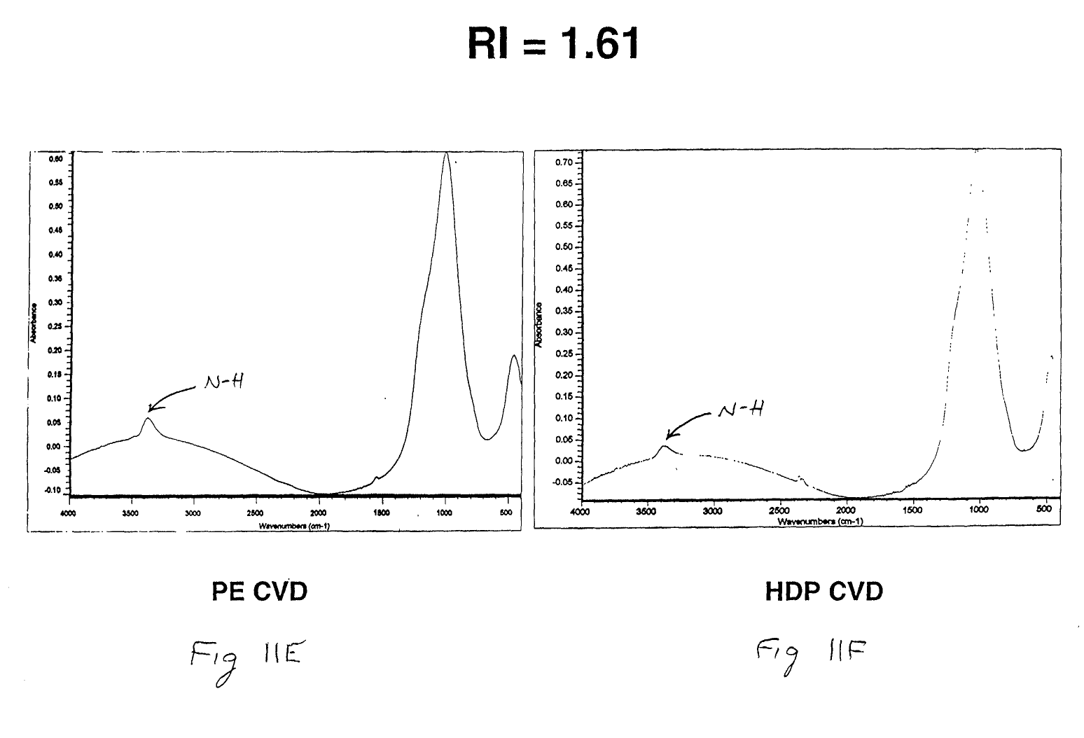

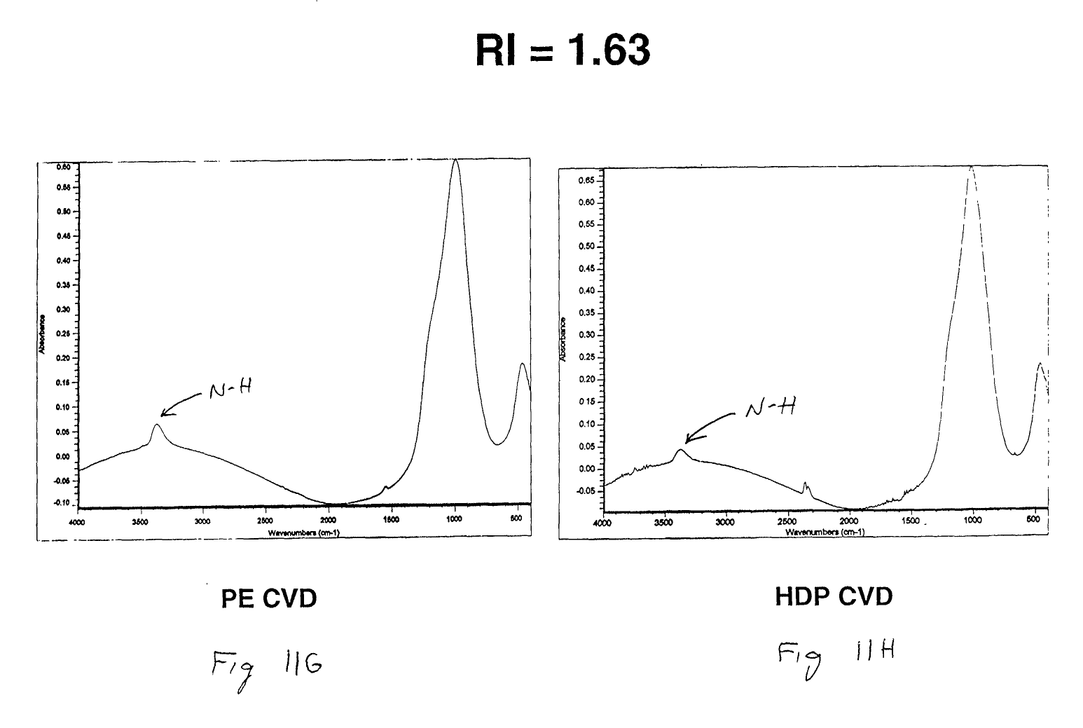

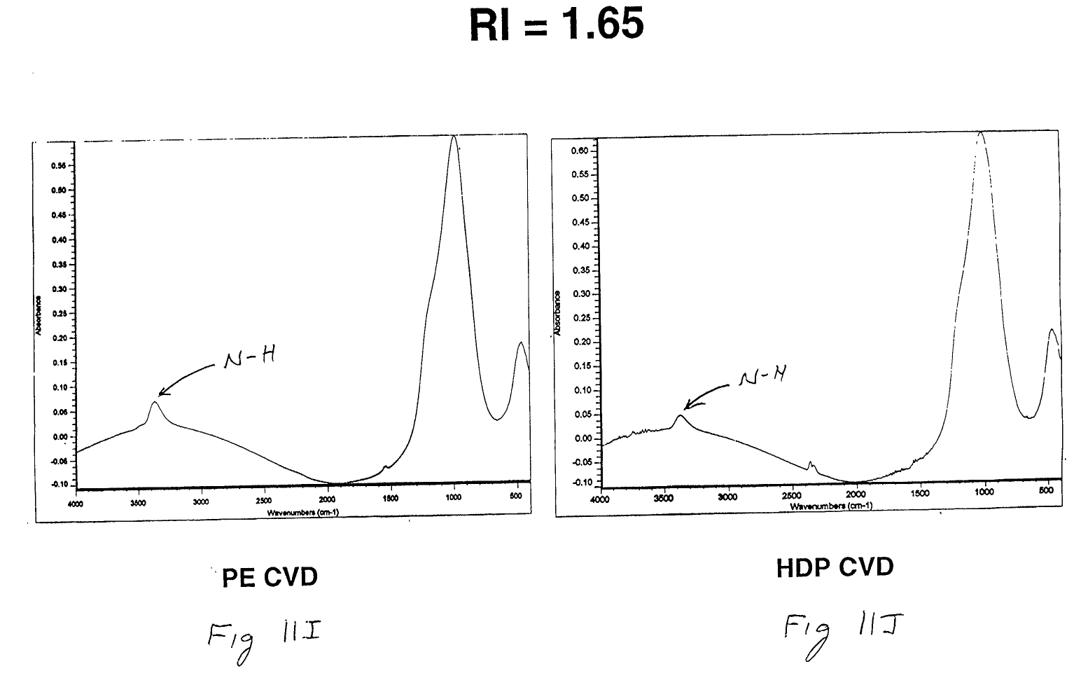

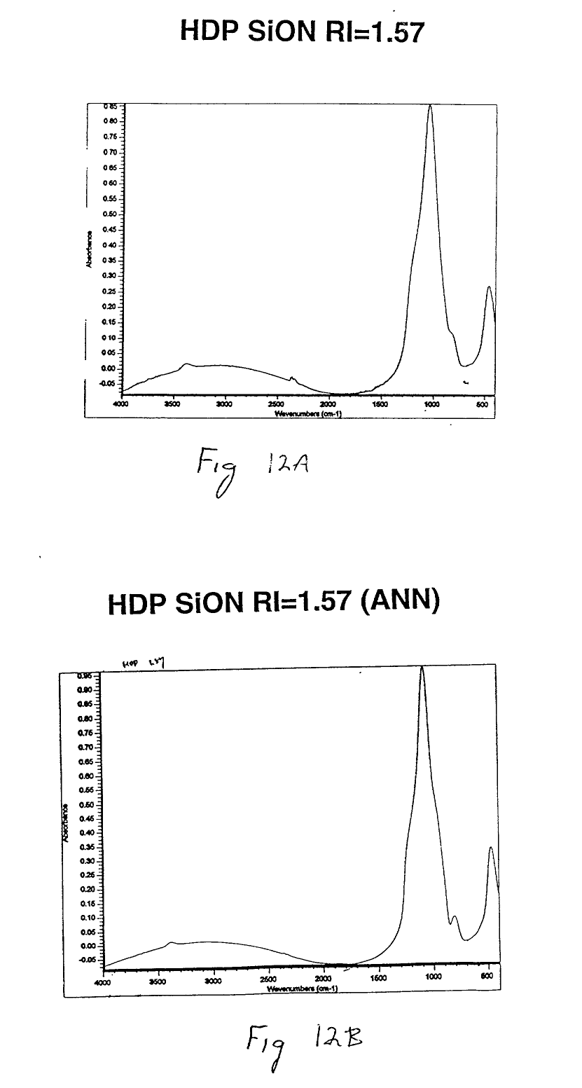

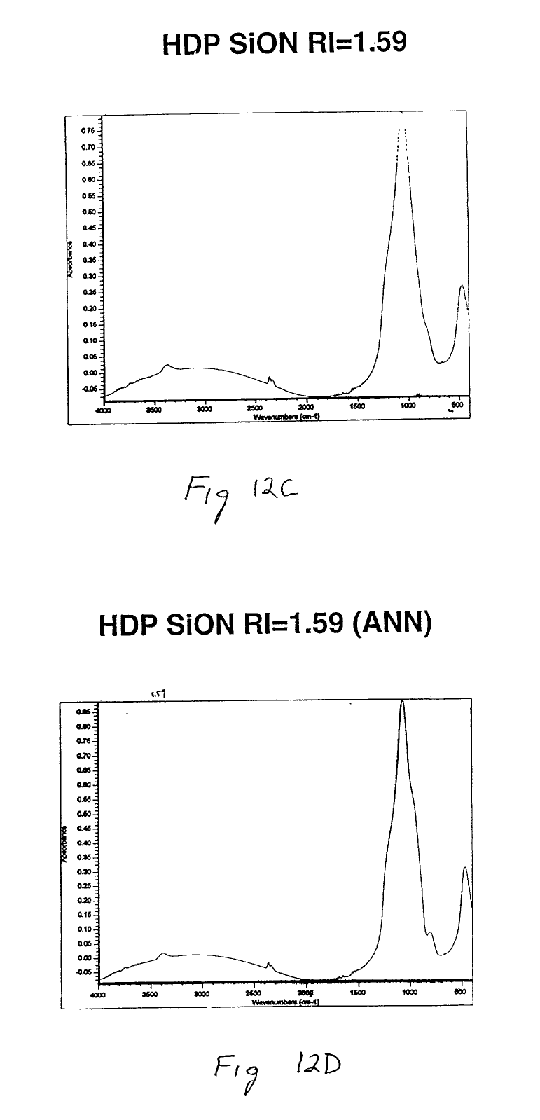

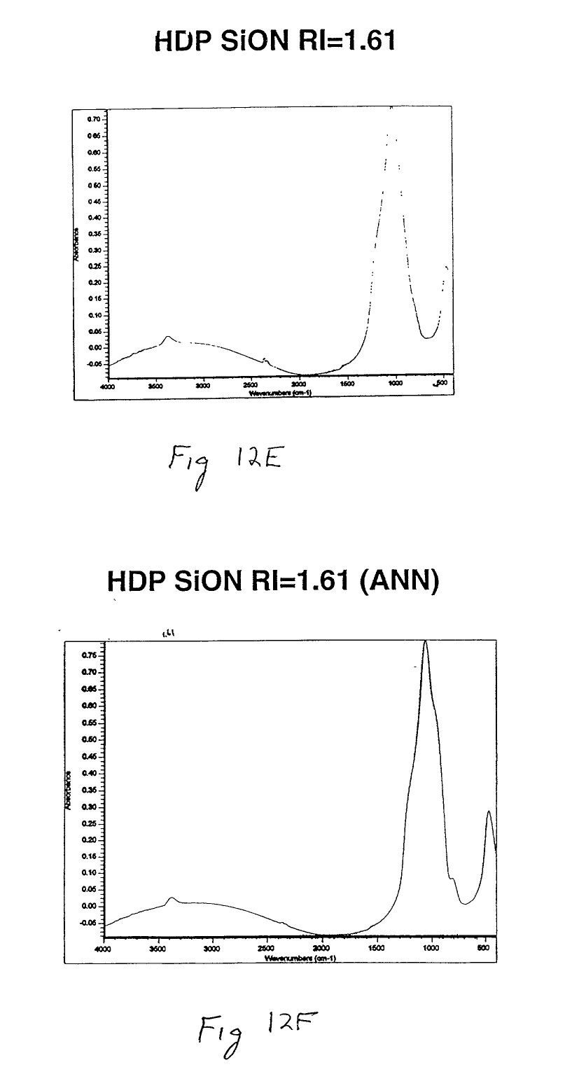

FIG. 10A illustrates one embodiment of a high density plasma substrate processing system 10 in which an optical core deposited in accordance with the present invention can be formed. System 10 includes a chamber 13, a vacuum system 70, a source plasma system 80A, a bias plasma system 80B, a gas delivery system 33, and a remote plasma cleaning system 50.

The upper portion of chamber 13 includes a dome 14, which is made of a ceramic dielectric material, such as aluminum oxide or aluminum nitride. Dome 14 defines an upper boundary of a plasma processing region 16. Plasma processing region 16 is bounded on the bottom by the upper surface of a substrate 17 and a substrate support member 18.

A heater plate 23 and a cold plate 24 surmount, and are thermally coupled to, dome 14. Heater plate 23 and cold plate 24 allow control of the dome temperature to within about ±10° C. over a range of about 100° C. to 200° C. This allows optimizing the dome temperature for the various processes. For example, it may be desirable to maintain the dome at a higher temperature for cleaning or etching processes than for deposition processes. Accurate control of the dome temperature also reduces the flake or particle counts in the chamber and improves adhesion between the deposited layer and the substrate.

The lower portion of chamber 13 includes a body member 22, which joins the chamber to the vacuum system. A base portion 21 of substrate support member 18 is mounted on, and forms a continuous inner surface with, body member 22. Substrates are transferred into and out of chamber 13 by a robot blade (not shown) through an insertion/removal opening (not shown) in the side of chamber 13. Lift pins (not shown) are raised and then lowered under the control of a motor (also not shown) to move the substrate from the robot blade at an upper loading position 57 to a lower processing position 56 in which the substrate is placed on a substrate receiving portion 19 of substrate support member 18. Substrate receiving portion 19 includes an electrostatic chuck 20 that secures the substrate to substrate support member 18 during substrate processing. In a preferred embodiment, substrate support member 18 is made from an aluminum oxide or aluminum ceramic material.

Vacuum system 70 includes throttle body 25, which houses twin-blade throttle valve 26 and is attached to gate valve 27 and turbo-molecular pump 28. It should be noted that throttle body 25 offers minimum obstruction to gas flow, and allows symmetric pumping. Gate valve 27 can isolate pump 28 from throttle body 25, and can also control chamber pressure by restricting the exhaust flow capacity when throttle valve 26 is fully open. The arrangement of the throttle valve, gate valve, and turbo-molecular pump allow accurate and stable control of chamber pressures from between about 1 millitorr to about 2 torr.

The source plasma system 80A includes a top coil 29 and side coil 30, mounted on dome 14. A symmetrical ground shield (not shown) reduces electrical coupling between the coils. Top coil 29 is powered by top source RF (SRF) generator 32A, whereas side coil 30 is powered by side SRF generator 32B, allowing independent power levels and frequencies of operation for each coil. This dual coil system allows control of the radial ion density in chamber 13, thereby improving plasma uniformity. Side coil 30 and top coil 29 are typically inductively driven, which does not require a complimentary electrode. In a specific embodiment, the top source RF generator 32A provides up to 2,500 watts of RF power at nominally 2 MHz and the side source RF generator 32B provides up to 5,000 watts of RF power at nominally 2 MHz. The operating frequencies of the top and side RF generators may be offset from the nominal operating frequency (e.g. to 1.7-1.9 MHz and 1.9-2.1 MHz, respectively) to improve plasma-generation efficiency.

A bias plasma system 80B includes a bias RF (“BRF”) generator 32C and a bias matching network 32C. The bias plasma system 80B capacitively couples substrate portion 17 to body member 22, which act as complimentary electrodes. The bias plasma system 80B serves to enhance the transport of plasma species (e.g., ions) created by the source plasma system 80A to the surface of the substrate. In a specific embodiment, bias RF generator provides up to 5,000 watts of RF power at 13.56 MHz.

RF generators 32A and 32B include digitally controlled synthesizers and operate over a frequency range between about 1.8 to about 2.1 MHz. Each generator includes an RF control circuit (not shown) that measures reflected power from the chamber and coil back to the generator and adjusts the frequency of operation to obtain the lowest reflected power, as understood by a person of ordinary skill in the art. RF generators are typically designed to operate into a load with a characteristic impedance of 50 ohms. RF power may be reflected from loads that have a different characteristic impedance than the generator. This can reduce power transferred to the load. Additionally, power reflected from the load back to the generator may overload and damage the generator. Because the impedance of a plasma may range from less than 5 ohms to over 900 ohms, depending on the plasma ion density, among other factors, and because reflected power may be a function of frequency, adjusting the generator frequency according to the reflected power increases the power transferred from the RF generator to the plasma and protects the generator. Another way to reduce reflected power and improve efficiency is with a matching network.

Matching networks 32A and 32B match the output impedance of generators 32A and 32B with their respective coils 29 and 30. The RF control circuit may tune both matching networks by changing the value of capacitors within the matching networks to match the generator to the load as the load changes. The RF control circuit may tune a matching network when the power reflected from the load back to the generator exceeds a certain limit. One way to provide a constant match, and effectively disable the RF control circuit from tuning the matching network, is to set the reflected power limit above any expected value of reflected power. This may help stabilize a plasma under some conditions by holding the matching network constant at its most recent condition.

Other measures may also help stabilize a plasma. For example, the RF control circuit can be used to determine the power delivered to the load (plasma) and may increase or decrease the generator output power to keep the delivered power substantially constant during deposition of a layer.

A gas delivery system 33 provides gases from several sources, 34A-34F chamber for processing the substrate via gas delivery lines 38 (only some of which are shown). As would be understood by a person of skill in the art, the actual sources used for sources 34A-34F and the actual connection of delivery lines 38 to chamber 13 varies depending on the deposition and cleaning processes executed within chamber 13. Gases are introduced into chamber 13 through a gas ring 37 and/or a top nozzle 45. FIG. 10B is a simplified, partial cross-sectional view of chamber 13 showing additional details of gas ring 37.

In one embodiment, first and second gas sources, 34A and 34B, and first and second gas flow controllers, 35A′ and 35B′, provide gas to ring plenum 36 in gas ring 37 via gas delivery lines 38 (only some of which are shown). Gas ring 37 has a plurality of source gas nozzles 39 (only one of which is shown for purposes of illustration) that provide a uniform flow of gas over the substrate. Nozzle length and nozzle angle may be changed to allow tailoring of the uniformity profile and gas utilization efficiency for a particular process within an individual chamber. In a preferred embodiment, gas ring 37 has 12 source gas nozzles made from an aluminum oxide ceramic.

Gas ring 37 also has a plurality of oxidizer gas nozzles 40 (only one of which is shown), which in a preferred embodiment are co-planar with and shorter than source gas nozzles 39, and in one embodiment receive gas from body plenum 41. In some embodiments it is desirable not to mix source gases and oxidizer gases before injecting the gases into chamber 13. In other embodiments, oxidizer gas and source gas may be mixed prior to injecting the gases into chamber 13 by providing apertures (not shown) between body plenum 41 and gas ring plenum 36. In one embodiment, third and fourth gas sources, 34C and 34D, and third and fourth gas flow controllers, 35C and 35D′, provide gas to body plenum via gas delivery lines 38. Additional valves, such as 43B (other valves not shown), may shut off gas from the flow controllers to the chamber.

In embodiments where flammable, toxic, or corrosive gases are used, it may be desirable to eliminate gas remaining in the gas delivery lines after a deposition. This may be accomplished using a 3-way valve, such as valve 43B, to isolate chamber 13 from delivery line 38A and to vent delivery line 38A to vacuum foreline 44, for example. As shown in FIG. 10A, other similar valves, such as 43A and 43C, may be incorporated on other gas delivery lines. Such 3-way valves may be placed as close to chamber 13 as practical, to minimize the volume of the unvented gas delivery line (between the 3-way valve and the chamber). Additionally, two-way (on-off) valves (not shown) may be placed between a mass flow controller (“MFC”) and the chamber or between a gas source and an MFC. In one embodiment, a digital mass flow controller may be used. Digital mass flow controllers allow for increased precision in the flow rates, and thus allow for improved repeatability from wafer to wafer and system to system, which is important for optical applications and production environments.

Referring again to FIG. 10A, chamber 13 also has top nozzle 45 and top vent 46. Top nozzle 45 and top vent 46 allow independent control of top and side flows of the gases, which improves film uniformity and allows fine adjustment of the film's deposition and doping parameters. Top vent 46 is an annular opening around top nozzle 45. In one embodiment, first gas source 34A supplies source gas nozzles 39 and top nozzle 45. Source nozzle MFC 35A′ controls the amount of gas delivered to source gas nozzles 39 and top nozzle MFC 35A controls the amount of gas delivered to top gas nozzle 45. Similarly, two MFCs 35B and 35B′ may be used to control the flow of oxygen to both top vent 46 and oxidizer gas nozzles 40 from a single source of oxygen, such as source 34B. The gases supplied to top nozzle 45 and top vent 46 may be kept separate prior to flowing the gases into chamber 13, or the gases may be mixed in top plenum 48 before they flow into chamber 13. Separate sources of the same gas may be used to supply various portions of the chamber.

A remote microwave-generated plasma cleaning system 50 is provided to periodically clean deposition residues from chamber components. The cleaning system includes a remote microwave generator 51 that creates a plasma from a cleaning gas source 34E (e.g., molecular fluorine, nitrogen trifluoride, other fluorocarbons or equivalents) in reactor cavity 53. The reactive species resulting from this plasma are conveyed to chamber 13 through cleaning gas feed port 54 via applicator tube 55. The materials used to contain the cleaning plasma (e.g., cavity 53 and applicator tube 55) must be resistant to attack by the plasma. The distance between reactor cavity 53 and feed port 54 should be kept as short as practical, since the concentration of desirable plasma species may decline with distance from reactor cavity 53. Generating the cleaning plasma in a remote cavity allows the use of an efficient microwave generator and does not subject chamber components to the temperature, radiation, or bombardment of the glow discharge that may be present in a plasma formed in situ. Consequently, relatively sensitive components, such as electrostatic chuck 20, do not need to be covered with a dummy wafer or otherwise protected, as may be required with an in situ plasma cleaning process.

System controller 60 controls the operation of system 10. In a preferred embodiment, controller 60 includes a memory 62, such as a hard disk drive, a floppy disk drive (not shown), and a card rack (not shown) coupled to a processor 61. The card rack may contain a single-board computer (SBC) (not shown), analog and digital input/output boards (not shown), interface boards (not shown), and stepper motor controller boards (not shown). The system controller conforms to the Versa Modular European (“VME”) standard, which defines board, card cage, and connector dimensions and types. The VME standard also defines the bus structure as having a 16-bit data bus and 24-bit address bus. System controller 31 operates under the control of a computer program stored on the hard disk drive or through other computer programs, such as programs stored on a removable disk. The computer program dictates, for example, the timing, mixture of gases, RF power levels and other parameters of a particular process. The interface between a user and the system controller is via a monitor, such as a cathode ray tube (“CRT”) 65, and a light pen 66, as depicted in FIG. 10C.

FIG. 10C is an illustration of a portion of an exemplary system user interface used in conjunction with the exemplary CVD processing chamber of FIG. 10A. System controller 60 includes a processor 61 coupled to a computer-readable memory 62. Preferably, memory 62 may be a hard disk drive, but memory 62 may be other kinds of memory, such as ROM, PROM, and others.

System controller 60 operates under the control of a computer program 63 stored in a computer-readable format within memory 62. The computer program dictates the timing, temperatures, gas flows, RF power levels and other parameters of a perticular process. The interface between a user and the system controller is via a CRT monitor 65 and a light pen 66, as depicted in FIG. 10C. In a preferred embodiment, two monitors, 65 and 65A, and two light pens, 66 and 66A, are used, one mounted in the clean room wall (65) for the operators and the other behind the wall (65A) for the service technicians. Both monitors simultaneously display the same information, but only one light pen (e.g. 66) is enabled. To select a particular screen or function, the operator touches an area of the display screen and pushes a button (not shown) on the pen. The touched area confirms being selected by the light pen by changing its color or displaying a new menu, for example.

The computer program code can be written in any conventional computer-readable programming language such as 68000 assembly language, C, C++, or Pascal. Suitable program code is entered into a single file, or multiple files, using a conventional text editor and is stored or embodied in a computer-usable medium, such as a memory system of the computer. If the entered code text is in a high level language, the code is compiled, and the resultant compiler code is then linked with an object code of precompiled windows library routines. To execute the linked compiled object code, the system user invokes the object code causing the computer system to load the code in memory. The CPU reads the code from memory and executes the code to perform the tasks identified in the program.

FIG. 10D shows an illustrative block diagram of the hierarchical control structure of computer program 100. A user enters a process set number and process chamber number into a process selector subroutine 110 in response to menus or screens displayed on the CRT monitor by using the light pen interface. The process sets are predetermined sets of process parameters necessary to carry out specified processes, and are identified by predefined set numbers. Process selector subroutine 110 identifies (i) the desired process chamber in a multichamber system, and (ii) the desired set of process parameters needed to operate the process chamber for performing the desired process. The process parameters for performing a specific process relate to conditions such as process gas composition and flow rates, temperature, pressure, plasma conditions such as RF power levels, and chamber dome temperature, and are provided to the user in the form of a recipe. The parameters specified by the recipe are entered utilizing the light pen/CRT monitor interface.

The signals for monitoring the process are provided by the analog and digital input boards of system controller 60, and the signals for controlling the process are output on the analog and digital output boards of system controller 60.

A process sequencer subroutine 120 comprises program code for accepting the identified process chamber and set of process parameters from the process selector subroutine 110 and for controlling operation of the various process chambers. Multiple users can enter process set numbers and process chamber numbers, or a single user can enter multiple process set numbers and process chamber numbers; sequencer subroutine 120 schedules the selected processes in the desired sequence. Preferably, sequencer subroutine 120 includes a program code to perform the steps of (i) monitoring the operation of the process chambers to determine if the chambers are being used, (ii) determining what processes are being carried out in the chambers being used, and (iii) executing the desired process based on availability of a process chamber and type of process to be carried out. Conventional methods of monitoring the process chambers can be used, such as polling. When scheduling which process is to be executed, sequencer subroutine 120 can be designed to take into consideration the “age” of each particular user-entered request, or the present condition of the process chamber being used in comparison with the desired process conditions for a selected process, or any other relevant factor a system programmer desires to include for determining scheduling priorities.

After sequencer subroutine 120 determines which process chamber and process set combination is going to be executed next, sequencer subroutine 120 initiates execution of the process set by passing the particular process set parameters to a chamber manager subroutine 130A-C, which controls multiple processing tasks in chamber 13 and possibly other chambers (not shown) according to the process set sent by sequencer subroutine 120.

Examples of chamber component subroutines are substrate positioning subroutine 340, process gas control subvoutine 150, pressure control subroutine 160, and plasma control subroutine 170. Those having ordinary skill in the art will recognize that other chamber control subroutines can be included depending on what processes are selected to be performed in chamber 13. In operation, chamber manager subroutine 130A selectively schedules or calls the process component subroutines in accordance with the particular process set being executed. Chamber manager subroutine 130A schedules process component subroutines in the same manner that sequencer subroutine 120 schedules the process chamber and process set to execute. Typically, chamber manager subroutine 130A includes steps of monitoring the various chamber components, determining which components need to be operated based on the process parameters for the process set to be executed, and causing execution of a chamber component subroutine responsive to the monitoring and determining steps.

Operation of particular chamber component subroutines will now be described with reference to FIGS. 10A and 10D. Substrate positioning subroutine 140 comprises program code for controlling chamber components that are used to load a substrate onto substrate support number 18. Substrate positioning subroutine 140 may also control transfer of a substrate into chamber 13 from, e.g., a plasma-enhanced CVD (“PECVD”) reactor or other reactor in the multi-chamber system, after other processing has been completed.

Process gas control subroutine 150 has program code for controlling process gas composition and flow rates. Subroutine 150 controls the open/close position of the safety shut-off valves and also ramps up/ramps down the mass flow controllers to obtain the desired gas flow rates. All chamber component subroutines, including process gas control subroutine 150, are invoked by chamber manager subroutine 130A. Subroutine 150 receives process parameters from chamber manager subroutine 130A related to the desired gas flow rates.

Typically, process gas control subroutine 150 opens the gas supply lines, and repeatedly (i) reads the necessary mass flow controllers, (ii) compares the readings to the desired flow rates received from chamber manager subroutine 130A, and (iii) adjusts the flow rates of the gas supply lines as necessary. Furthermore, process gas control subroutine 150 may include steps for monitoring the gas flow rates for unsafe rates and for ectivating the safety shut-off valves when an unsafe condition is detected.

In some processes, an inert gas, such as argon, is flowed into chamber 13 to stabilize the pressure in the chamber before reactive process gases are introduced. For these processes, the process gas control subroutine 150 is programmed to include steps for flowing the inert gas into chamber 13 for an amount of time necessary to stabilize the pressure in the chamber. The steps described above may then be carried out.

Additionally, when a process gas is to be vaporized from a liquid precursor, for example, tetraethylorthosilane (TEOS), the process gas control subroutine 150 may include steps for bubbling a delivery gas such as helium through the liquid precursor in a bubbler assembly or for introducing the helium to a liquid injection valve. For this type of process, the process gas control subroutine 150 regulates the flow of the delivery gas, the pressure in the bubbler, and the bubbler temperature to obtain the desired process gas flow rates. As discussed above, the desired process gas flow rates are transferred to process gas control subroutine 150 as process parameters.

Furthermore, the process gas control subroutine 150 includes steps for obtaining the necessary delivery gas flow rate, bubbler pressure, and bubbler temperature for the desired process gas flow rate by accessing a stored table containing the necessary values for a given process gas flow rate. Once the necessary values are obtained, the delivery gas flow rate, bubbler pressure and bubbler temperature are monitored, compared to the necessary values and adjusted accordingly.

The process gas control subroutine 150 may also control the flow of heat-transfer gas, such as helium (He), through the inner and outer passages in the wafer chuck with an independent helium control (IHC) subroutine (not shown). The gas flow thermally couples the substrate to the chuck. In a typical process, the wafer is heated by the plasma and the chemical reactions that form the layer, and the He cools the substrate through the chuck, which may be water-cooled. This keeps the substrate below a temperature that may damage preexisting features on the substrate.

Pressure control subroutine 160 includes program code for controlling the pressure in chamber 13 by regulating the size of the opening of throttle valve 26 in the exhaust portion of the chamber. There are at least two basic methods of controlling the chamber with the throttle valve. The first method relies on characterizing the chamber pressure as it relates to, among other things, the total process gas flow, the size of the process chamber, and the pumping capacity. The first method sets throttle valve 26 to a fixed position. Setting throttle valve 26 to a fixed position may eventually result in a steady-state pressure.

Alternatively, the chamber pressure may be measured, with a manometer for example, and the position of throttle valve 26 may be adjusted according to pressure control subroutine 360, assuming the control point is within the boundaries set by gas flows and exhaust capacity. The former method may result in quicker chamber pressure changes, as the measurements, comparisons, and calculations associated with the latter method are not invoked. The former method may be desirable where precise control of the chamber pressure is not required, whereas the latter method may be desirable where an accurate, repeatable, and stable pressure is desired, such as during the deposition of a layer.

When pressure control subroutine 160 is invoked, the desired, or target, pressure level is received as a parameter from chamber manager subroutine 130A. Pressure control subroutine 160 measures the pressure in chamber 13 by reading one or more conventional pressure manometers connected to the chamber; compares the measured value(s) to the target pressure; obtains proportional, integral, and differential (PID) values from a stored pressure table corresponding to the target pressure, and adjusts throttle valve 26 according to the PID values obtained from the pressure table. Alternatively, pressure control subroutine 160 may open or close throttle valve 26 to a particular opening size to regulate the pressure in chamber 13 to a desired pressure or pressure range.

Plasma control subroutine 170 comprises program code for controlling the frequency and power output setting of RF generators 32A and 32B and for tuning matching networks 32A and 32B. Plasma control subroutine 370, like the previously described chamber component subroutines, is invoked by chamber manager subroutine 330A.

An example of a system that may incorporate some or all of the subsystems and routines described above would be the ULTIMA™ system, manufactured by APPLIED MATERIALS, INC., of Santa Clara, Calif., configured to practice the present invention. Further details of such a system are disclosed in the copending, commonly assigned U.S. patent application Ser. No. 08/679,927, filed Jul. 15, 1996, entitled “Symmetric Tunable Inductively-Coupled HDP-CVD Reactor,” having Fred C. Redeker, Farhad Moghadam, Hirogi Hanawa, Tetsuya Ishikawa, Dan Maydan, Shijian Li, Brian Lue, Robert Steger, Yaxin Wang, Manus Wong and Ashok Sinha listed as co-inventors, the disclosure of which is incorporated herein by reference. The described system is for exemplary purpose only. It would be a matter of routine skill for a person of skill in the art to select an appropriate conventional substrate processing system and computer control system to implement the present invention.

The system described above is generally suitable for performing high-density plasma deposition using a chemical-vapor deposition process. Other high-density plasma techniques that may be used alternatively will be evident to those of skill in the art. For example, in one embodiment, a high-density plasma electron-cyclotron resonance (HDP-ECR) technique is used. Such a technique couples power electromagnetically to produce the high-density plasma. One embodiment of an HDP-ECR device is described in, for example, U.S. Pat. No. 4,948,458, entitled “Method and apparatus for producing magnetically-coupled planar plasma,” issued to Ogle on Aug. 14, 1990, the entire disclosure of which is herein incorporated by reference for all purposes.

3. Experimental Results

Table 3 below illustrates a comparison of the hydrogen content and propagation loss achieved for a PECVD process and an HDP-CVD process according to one embodiment of the present invention. The hydrogen content has been normalized with respect to PECVD carried out at 400° C. for illustrative purposes.

TABLE 3

| Process | H-content | Propagation Loss |
|---|---|---|
| PECVD @ 400 ° C. | 1 | 20 dB |
| HDP-CVD | .25 | 9 dB |

Table 3 illustrates an 11 dB reduction in propagation loss when an HDP-CVD process is used instead of a PECVD process to form an optical core.

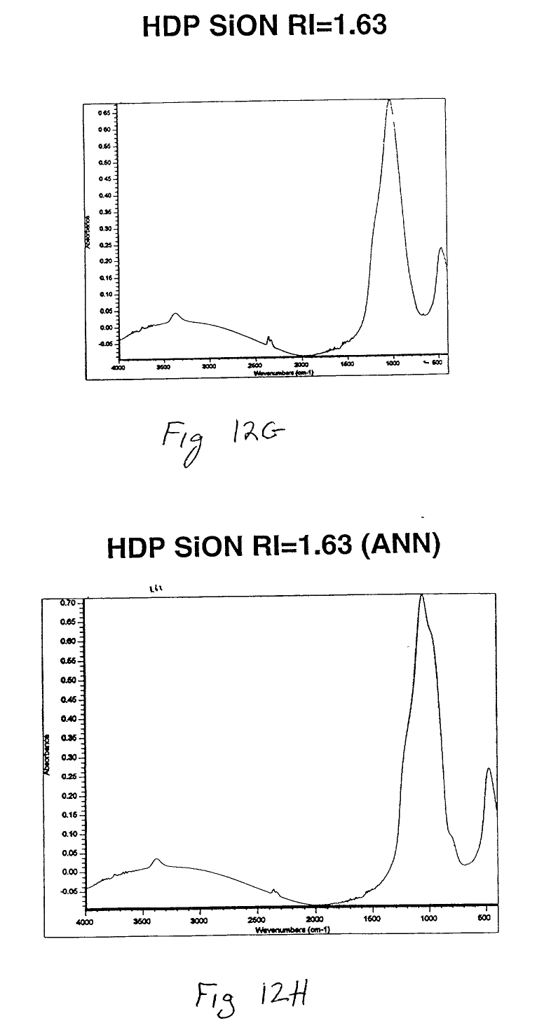

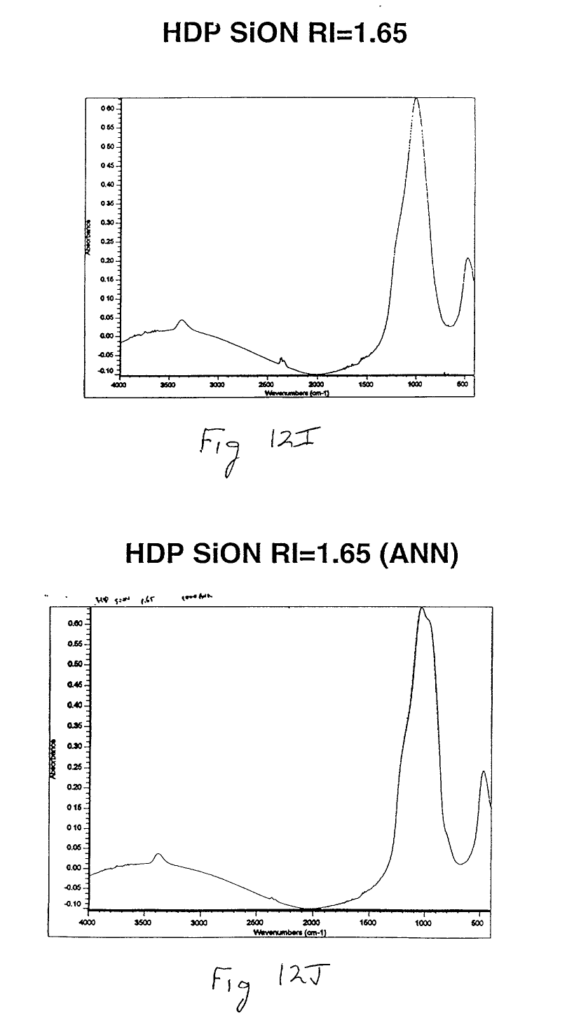

A number of experiments have been performed to assess and characterize the effectiveness of embodiments of the invention in producing the desired physical properties for the optical cores. Results from such experiments are presented in FIGS. 11 and 12.

FIGS. 11A-J illustrate a comparison of a Fourier-transform infrared spectrum of an SiON core deposited using PECVD and HDP-CVD for refractive indices of 1.57-1.65. FIGS. 11A and 11B compare the absorbance for an SiON core having a refractive index (“RI”) of 1.57 formed using PECVD and HDP-CVD, respectively. One particularly unexpected characteristic is the drastically reduced absorbance contribution from NH at approximately 3340 cm⁻¹ when using a high-density process, such as HDP-CVD, rather than PECVD. This reduction in absorbance has been found to correspond to a substantial reduction in propagation loss in the optical waveguide. FIGS. 11C-D, 11E-F, 11G-H, and 11I-J compare the absorbance for SiON cores having an RI of 1.59, 1.61, 1.63, and 1.65 formed using PECVD and HDP-CVD, respectively. These graphs illustrate that as the refractive index of the core is increased, the absorbance from NH increases drastically, leading to a corresponding substantial increase in propagation loss. Thus, PECVD deposited SiON cores have unacceptable levels of propagation loss for manufacturing optical waveguides. However, the FIGS. 11A-J also illustrate a large reduction in the absorbance contribution from NH when moving from a PECVD process to a high-density process such as HDP-CVD. Accordingly, the inventors have discovered that a large reduction in propagation loss (e.g., approximately an order of magnitude) may be achieved by using a high-density plasma process, such as HDP-CVD, rather than a PECVD process.

FIGS. 12A-J illustrate a comparison of a Fourier-transform infrared spectrum of an SiON core before and after annealing for refactive indices of 1.57-1.65. FIGS. 12A and 12B compare the absorbance for an SiON core having a refractive index (“RI”) of 1.57 formed using HDP-CVD before and after anneal, respectively. The inventors have discovered that further reductions in propagation loss may be achieved by an anneal process step after the high-density plasma despostion processing of the optical core. The absorbance contribution from NH at approximately 3340 cm⁻¹ is again further reduced when using an anneal step after the high-density plasma deposition process step. As mentioned above, this reduction in absorbance corresponds to a substantial reduction in propagation loss in the optical waveguide. FIGS. 12C-D, 12E-F, 12G-H, and 12I-J compare the absorbance for SiON cores having an RI of 1.59, 1.61, 1.63, and 1.65 formed HDP-CVD with an anneal step, respectively.

As can be seen from the above detailed description, it is advantageous to use a high-density plasma deposition process to fabricate optical waveguide core structures. Also, developments from the semiconductor industry may be adapted and modified to optical applications enabling embodiments of the invention to be readily and advantageously adapted to production-scale levels.

Having fully described several embodiments of the present invention, many other equivalent or alternative methods of forming an optical waveguide core using a high-density plasma process according to the present invention will be apparent to those skilled in the art. These alternatives and equivalents are intended to be included within the scope of the present invention.

What is claimed is:

1. A method of forming an optical waveguide on an undercladding layer of a substrate, the method comprising:
forming at least one silicate glass optical core on said undercladding layer using a high-density plasma deposition process including a silicon source gas and an oxygen source gas;
wherein the refractive index of the undercladding layer is less than the refractive index of the optical core.

2. The method of claim 1 wherein the high-density plasma process comprises pressure of less than 100 millitorr and an RF energy greater than 3 Watts/cm².

3. The method of claim 2 wherein the high-density plasma process further comprises a nitrogen source gas and the optical core comprises silicon, oxygen, and nitrogen.

4. The method of claim 3 wherein the nitrogen source gas is molecular nitrogen.

5. The method of claim 3 wherein the optical core is an SiON optical core.

6. The method of claim 3 wherein the ratio of oxygen atoms to silicon atoms is greater than 3:1.

7. The method of claim 3 wherein the silicon source comprises silane, the oxygen source comprises molecular oxygen, and the nitrogen source comprises molecular nitrogen.

8. The method of claim 7 wherein the ratio of molecular oxygen to silane is greater than 1.5:1.

9. The method of claim 7 wherein the oxygen source flow is between 200-600 sccm.

10. The method of claim 7 wherein the ratio of molecular nitrogen to silane is between 0.5 and 5.0.

11. The method of claim 7 wherein the nitrogen source flow is between 300-500 sccm.

12. The method of claim 1 wherein the high-density plasma process is carried out at a temperature of greater than 600° C.

13. The method of claim 1 wherein the optical core comprises a phosphorus doped silicate glass or germanium doped silicate glass.

14. The method of claim 1 wherein the contrast between the refractive index of the core and the refractive index of the undercladding layer is greater than 2%.

15. The method of claim 1 wherein forming at least one optical core comprises:
depositing a continuous optical core layer using said high-density plasma deposition process; and
etching the continuous optical core layer to form the at least one optical core.

16. The method of claim 15 wherein the depositing using said high-density plasma deposition process does not use an RF bias.

17. The method of claim 1 wherein forming at least one optical core comprises:
etching at least one trench in the undercladding layer;
depositing the at least one optical core in the corresponding at least one trench using said high-density plasma deposition process; and
depositing an uppercladding layer over the at least one optical core.

18. The method of claim 17 wherein the depositing using said high-density plasma deposition process does includes an RF bias.

19. The method of claim 1 wherein said high-density plasma deposition process is a high-density plasma electron-cyclotron resonance process.

20. The method of claim 1 wherein said high-density plasma deposition process is a high-density plasma chemical vapor deposition process.

21. The method of claim 1 further comprising annealing the at least one optical core after the high-density plasma deposition process.

22. A method of depositing an optical core on a substrate in a processing chamber comprising:
establishing a pressure of less than 100 millitorr in said processing chamber;
generating an RF power density of greater than 3 Watts/cm²; and
providing a silicon source gas, an oxygen source gas, and a dopant source gas in said processing chamber, wherein the dopant source gas increases the refractive index of said optical core above 1.46.

23. The method of claim 22 wherein the ratio of oxygen atoms to silicon atoms is greater than 3:1.

24. The method of claim 22 wherein the dopant source gas is a nitrogen source gas and the optical core comprises silicon, oxygen, and nitrogen.

25. The method of claim 24 wherein said nitrogen source gas is molecular nitrogen.

26. The method of claim 25 wherein the silicon source gas is silane.

27. The method of claim 26 wherein the ratio of molecular nitrogen to silane is between 0.5 and 5.0.

28. The method of claim 22 wherein the dopant source gas is a phosphorus containing gas or germanium containing gas.

29. A substrate processing system comprising:
a housing defining a process chamber;
a high-density plasma generating system operatively coupled to the process chamber;
a substrate holder configured to hold a substrate during substrate processing;
a gas-delivery system configured to introduce gases into the process chamber, including sources for a silicon-containing gas, an oxygen-containing gas, and a dopant-containing gas;
a pressure-control system for maintaining a selected pressure within the process chamber;
a controller for controlling the high-density plasma generating system, the gas-delivery system, and the pressure-control system; and
a memory coupled to the controller, the memory comprising a computer-readable medium having a computer-readable program embodied therein for directing operation of the substrate processing system to form an optical core a substrate, the computer-readable program including
instructions to flow a gaseous mixture containing flows of the silicon-containing gas, the oxygen-containing gas, and the dopant-containing gas;
instructions to maintain a pressure of less than 100 millitorr within the process chamber; and
instructions to provide an RF power density greater than 3 Watts/cm² into the process chamber, and in accordance therewith, generate a high-density plasma from the gaseous mixture and deposit a doped silicate glass optical core, wherein the dopant-containing gas increases the refractive index of said optical core above 1.46.

30. The substrate processing system of claim 29 wherein the ratio of oxygen atoms to silicon atoms is greater than 3:1.

31. The substrate processing system of claim 29 wherein the dopant-containing gas comprises a nitrogen-containing gas and the optical core comprises silicon, oxygen, and nitrogen.

32. The substrate processing system of claim 31 wherein the silicon-containing comprises silane and the nitrogen-containing gas includes molecular nitrogen.

33. The substrate processing system of claim 32 wherein the ratio of molecular nitrogen to silane is between 0.5 and 5.0.

34. The substrate processing system of claim 29 wherein the substrate holder comprises an electrostatic chuck, and wherein computer-readable program further includes instructions for turning electrostatic chuck off during deposition of the silicate glass optical core.

35. The substrate processing system of claim 29 further comprising a top RF source and a side RF source, wherein the ratio of power of the top RF source to the side RF source is between 0.21 and 0.73.

36. The substrate processing system of claim 29 wherein the dopant containing gas is a phosphorus containing gas or germanium containing gas.

37. A computer-readable storage medium having a computer-readable program embodied therein for directing operation of a substrate processing system including a process chamber; a plasma generation system; and a gas delivery system configured to introduce gases into the process chamber, the computer-readable program including instructions for operating the substrate processing system to form an optical core on a substrate disposed in the processing chamber in accordance with the following:
establishing a pressure of less than 100 millitorr in said processing chamber;
generating an RF power density of greater than 3 Watts/cm²; and
providing a silicon source gas, an oxygen source gas, and a dopant source gas in said processing chamber, wherein the dopant source gas increases the refractive index of said optical core above 1.46.

38. The computer-readable storage medium of claim 37 wherein the ratio of oxygen atoms to silicon atoms is greater than 3:1.

39. The computer-readable storage medium of claim 37 wherein the dopant source gas is a nitrogen source gas and the optical core comprises silicon, oxygen, and nitrogen.

40. The computer-readable storage medium of claim 39 wherein said nitrogen source gas is molecular nitrogen and the silicon source is silane.

41. The computer-readable storage medium of claim 40 wherein the ratio of molecular nitrogen to silane is between 0.5 and 5.0.

42. The computer-readable storage medium of claim 37 wherein the dopant source gas is a phosphorus containing gas or germanium containing gas.
